(19) United States
(12) Patent Application Publication
(10) Pub. No.: US 2010/0170283 A1
(43) Pub. Date: Jul. 8, 2010

(54) Compressor Controller

(76) Inventor: Makoto Shibuya, Gunma (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/663,481

(22) PCT Filed: May 22, 2008
(86) PCT No.: PCT/JP2008/059467

§ 371 Date: Dec. 7, 2009

(30) Foreign Application Priority Data
Jun. 7, 2007 (JP) 2007-151482

(51) Int. Cl. F25B 27/00; G05B 15/00

(52) U.S. Cl. 62/323.4; 700/275

(57) ABSTRACT

An air-con ECU (10) consists of one type of a control unit producing and transmitting a signal to engage or disengage an electromagnetic clutch (44) of an engine-driven compressor (40), on the basis of environmental parameter signals transmitted from environmental parameter detection means (20 to 25), and also retransmitting the environmental parameter signals. An electromagnetic portion of the electromagnetic clutch (44) engages or disengages the electromagnetic clutch of the engine-driven compressor by selectively receiving the signal to engage or disengage the electromagnetic clutch (clutch engage/disengage signal) transmitted from the air-con ECU, and an electric motor control portion (34) of an electric compressor (30) controls rotation of an electric motor of the electric compressor by selectively receiving the environmental parameter signals (various sensor values) transmitted from the air-con ECU.

### TECHNICAL FIELD

This invention relates to a compressor controller, specifically a technique for controlling a compressor of an automotive air conditioner.

### BACKGROUND ART

Generally, conventional automotive air-conditioners (hereinafter, “air-conditioner” will be abbreviated to “air-con”) are arranged such that a compressor constituting a refrigeration cycle is driven by drive power of an engine. In such engine-driven compressor, a clutch is provided between the engine and the compressor, and the output of the compressor is regulated by engaging or disengaging the clutch according to a clutch control instruction calculated by an air-con electronic control unit (air-con ECU) on the basis of information from various sensors.

Recently, the use of electric compressors driven by power of a battery is increasing. In such electric compressor, the output of the compressor is regulated by controlling revolving speed of an electric motor according to a target revolving speed calculated by an air-con ECU on the basis of information from various sensors.

Since both the engine-driven compressor and the electric compressor are provided for use, there can be a case such that in spite of the same vehicle model, some vehicles are equipped with an engine-driven compressor and others are with an electric compressor, according to different vehicle specifications, etc. In such case, different air-con ECUs adapted for the respective types of compressors are required.

Preparing two types of air-con ECUs is, however, costly with respect to management as well as manufacture.

Thus, preparing an air-con ECU usable with both types of compressors is conceivable.

In this case, however, the air-con ECU needs to be able to perform two different functions, namely calculating a clutch control instruction and calculating a revolving speed instruction. Compared with the calculation of the clutch control instruction, the calculation of the revolving speed instruction is complicated and requires a high-capacity, and therefore costly air-con ECU. Thus, there is a problem that although the engine-driven compressor does not require high ECU capacity, the air-con ECU usable with both types of compressors is expensive to manufacture.

In this connection, for a hybrid vehicle equipped with an engine and an electric motor as drive sources, there has been developed an arrangement in which a hybrid ECU, provided aside from an air-con ECU, regulates the revolving speed of a compressor-driving electric motor (see Japanese Patent Application KOKAI Publication 2004-276908), for example.

The technique disclosed in the above publication is however not versatile, since the application thereof is restricted to such type of hybrid vehicles that allows a hybrid ECU to regulate the revolving speed of a compressor-driving electric motor.

In other words, if a hybrid ECU is not provided, it is necessary to prepare two types of air-con ECUs or prepare an air-con ECU usable with the two types of compressors, as mentioned above. Thus, the above-mentioned problems remain unsolved.

### DISCLOSURE OF THE INVENTION

The present invention has been made in view of the problems mentioned above. The primary object of the present invention is to provide a highly-versatile compressor controller capable of efficiently controlling an engine-driven compressor as well as an electric compressor, without requiring preparation of more than one type of an air-con ECU.

In order to achieve the above object, a compressor controller according to the present invention comprises an engine-driven compressor or an electric compressor constituting a refrigeration cycle of an automotive air conditioner; environmental parameter detection means for detecting environmental parameters required to control the automotive air conditioner; and an air-con control unit electrically connected to an electromagnetic portion of an electromagnetic clutch transmitting or ceasing to transmit drive power of an engine to the engine-driven compressor, or an electric motor control portion controlling rotation of an electric motor of the electric compressor, to control operation of the automotive air conditioner including the electromagnetic clutch or the electric motor, depending on the environmental parameters detected by the environmental parameter detection means, wherein the air-con control unit consists of one type of a control unit producing and transmitting an electromagnetic-clutch engage/disengage signal based on environmental parameter signals transmitted from the environmental parameter detection means, and also retransmitting the environmental parameter signals, and the electromagnetic portion of the electromagnetic clutch operates the engine-driven compressor by selectively receiving the electromagnetic-clutch engage/disengage signal transmitted from the air-con control unit and engaging or disengaging the electromagnetic clutch accordingly, and the electric motor control portion operates the electric compressor by selectively receiving the environmental parameter signals transmitted from the air-con control unit.

Thus, the compressor controller is allowed to have an air-con control unit usable with both the engine-driven compressor and the electric compressor and not having such specifications as fitted only to the processing for one of the two types of compressors and excessive for the other. Thus, compared with the case requiring preparation of more than one type of air-con control units adapted for different types of compressors, this compressor controller has an advantage that it can reduce the management cost as well as the manufacturing cost.

Thus, the present invention can provide a highly versatile compressor controller which can perform efficient control, whether the air conditioner includes an engine-driven compressor or an electric compressor.

It is desirable that the electric motor control portion of the electric compressor selectively receive the environmental parameter signals, obtain a target revolving speed based on the environmental parameter signals, and control rotation of the electric motor according to the target revolving speed.

When the electric motor control portion of the electric compressor directly obtains a target revolving speed for the electric motor of the electric compressor depending on the environmental parameters, the load on the air-con control unit is sufficiently reduced. This enables the same air-con control unit to be used with either type of compressor.

It is desirable that the electromagnetic portion of the electromagnetic clutch of the engine-driven compressor be electrically connected to the air-con control unit, and that the electric motor control portion of the electric compressor be connected to the air-con control unit by a LAN.

This allows the engine-driven compressor and the electric compressor to selectively receive their required signal/signals, thereby allowing the same air-con control to be used with either type of compressor.

### BRIEF DESCRIPTION OF THE DRAWINGS

FIG. 1 is a block diagram showing a compressor controller according to the present invention.

### BEST MODE OF CARRYING OUT THE INVENTION

Referring to the drawing, an embodiment of the present invention will be described below.

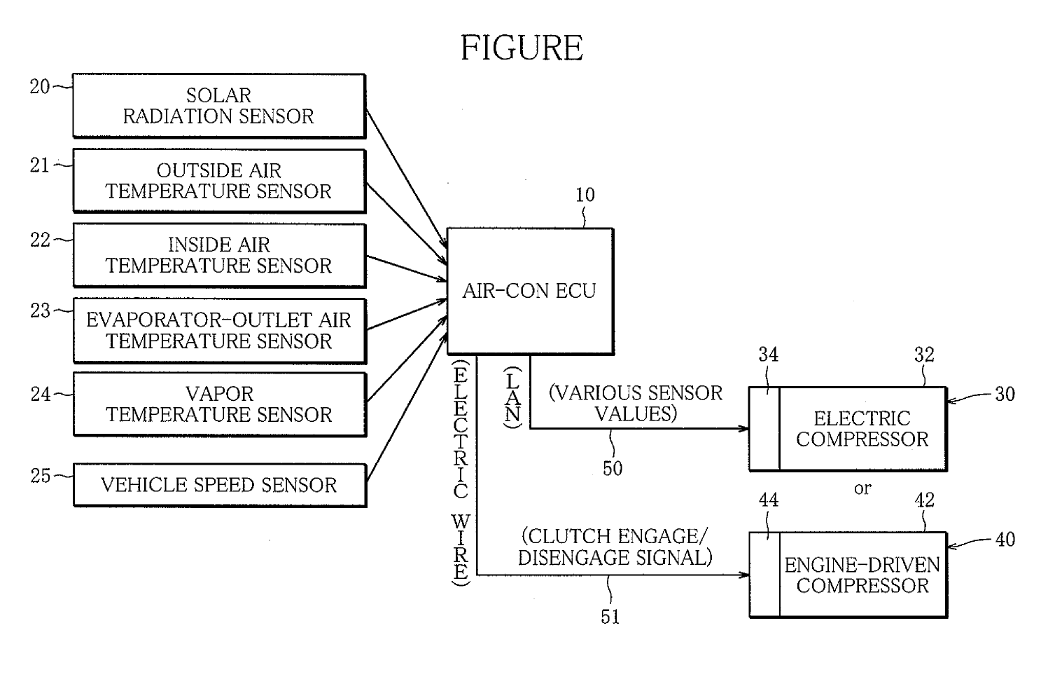

FIG. 1 is a block diagram showing a compressor controller according to the present invention.

The compressor controller is a component controlling the air-conditioning of an automotive air conditioner (hereinafter abbreviated to “air-con”) installed on a vehicle by controlling the operation of a refrigerant compressor constituting a refrigeration cycle. Since the general configuration and function of an air-con and of a refrigeration cycle is publicly known, the explanation thereof will be omitted.

As shown in the drawing, the compressor controller is constructed by electrically connecting a variety of sensors to an input of an air-con electronic control unit (hereinafter referred to as “air-con ECU”; air-con control unit) 10 and electrically connecting a compressor unit (compressor) to an output of the air-con ECU 10.

Specifically, to the input of the air-con ECU 10, a variety of sensors (environmental parameter detection means), such as a solar radiation sensor 20, an outside air temperature sensor 21, an inside air temperature sensor 22, an evaporator-outlet air temperature sensor 23, a vapor temperature sensor 24, a vehicle speed sensor, etc., are connected in order to obtain environmental parameters required to control the air-con. To the output thereof, either an electric compressor unit (electric compressor) 30 is connected by an in-vehicle LAN (in-vehicle local area network) 50 or a compressor unit driven by an engine (engine-driven compressor unit; engine-driven compressor) 40 is electrically connected by electric wire 51, depending on vehicle model or vehicle specifications. The electric compressor unit 30 includes an electric compressor body 32 equipped with an electric motor and an electric compressor ECU (electric motor control portion) 34, and is arranged such that the electric compressor ECU 34 controls the operation of the electric compressor body 32 according to signals from the air-con ECU 10. Here, the electric compressor body 32 is an electric scroll compressor, for example.

The engine-driven compressor unit 40 includes an engine-driven compressor body 42 and an electromagnetic clutch 44 transmitting or ceasing to transmit drive power of the engine (not shown) to the engine-driven compressor body 42, and is arranged such that while the electromagnetic clutch 44 is engaged according to a clutch engage/disengage signal from the air-con ECU 10, the engine-driven compressor body 42 operates depending on engine revolving speed. Here, the engine-driven compressor body 42 is, likewise, a scroll compressor, for example.

Specifically, the electric compressor ECU 34 of the electric compressor unit 30 has a function of selectively obtaining information from the sensors 20 to 25, through the air-con ECU 10, via the in-vehicle LAN 50, and directly setting a target revolving speed Nt for the electric motor of the electric compressor body 32, on the basis of the information from the sensors 20 to 25, and controls the operation of the electric compressor body 32 by the target revolving speed Nt thus set. It is to be noted that the electric compressor ECU 34 has a capacity enough to set the target revolving speed Nt, since it is originally intended to perform relatively heavy calculation loads.

The electromagnetic clutch 44 of the engine-driven compressor unit 40 is arranged such that an electromagnetic portion of the electromagnetic clutch 44 selectively receives a clutch engage/disengage signal produced and transmitted by the air-con ECU 10 on the basis of information from the sensors 20 to 25, via the electric wire 51, and electromagnetically engages or disengages the clutch according to the clutch engage/disengage signal.

Thus, the ECU 10 consists of one type of an integrated control unit having both a function of passing sensor values from the sensors 20 to 25 onto the in-vehicle LAN 50, for the electric compressor unit 30, and a function of producing a clutch engage/disengage signal on the basis of information from the sensors 20 to 25 and transmitting it via the electric wire 51, for the engine-driven compressor unit 40.

Since the air-con ECU 10 has only the function of passing information from the sensors 20 to 25 onto the in-vehicle LAN 50 and the function of producing and transmitting a clutch engage/disengage signal via the electric wire 51, its calculation load is light and its processing is relatively simple. Thus, the air-con ECU 10 only needs to be able to perform relatively simple processing, and therefore is produced with low capacity and inexpensive specifications.

Thus, whether the compressor controller according to the present invention controls the electric compressor unit 30 or the motor-driven compressor unit 40, the same air-con ECU 10 is used, wherein the air-con ECU 10 to be used with either of the electric compressor unit 30 and the motor-driven compressor unit 40 does not have such specifications as fitted only to the processing for one of them and excessive (wasteful) for the other. The compressor controller having such air-con ECU can be manufactured at reduced costs.

Further, compared with preparing more than one type of air-con ECUs, preparing one type of air-con ECUs 10 usable with different types of compressors can reduce the costs of management of compressor controllers.

Thus, for example in a hybrid vehicle equipped with an engine and an electric motor as drive sources, whether the air conditioner includes an electric compressor or an engine-driven compressor, the same air-con ECU 10 can be used; there is no need to prepare air-con ECUs adapted for the respective types of compressors.

As understood from the above, the present invention can provide a highly-versatile compressor controller which can perform efficient control, whether the air-conditioner has an electric compressor unit 30 or an engine-driven compressor unit 40.

In the above, an embodiment of the present invention has been described. The present invention is however not restricted to the above-described embodiment, but can be altered in various ways without departing from the scope and spirit of the present invention.

For example, although the described embodiment includes, as sensors obtaining environmental parameters, a solar radiation sensor 20, an outside air temperature sensor 21, an inside air temperature sensor 22, an evaporator-outlet air temperature sensor 23, a vapor temperature sensor 24 and a vehicle speed sensor 25, the sensors obtaining environmental parameters are not restricted to these; Other environmental parameters may be used.

Further, although in the described embodiment, the electric compressor body 32 as well as the engine-driven compressor body 42 is, for example an electric scroll compressor, the compressor type is not restricted to this.

1. A compressor controller, comprising:
an engine-driven compressor or an electric compressor constituting a refrigeration cycle of an automotive air conditioner,
environmental parameter detection means for detecting environmental parameters required to control the automotive air conditioner, and
an air-con control unit electrically connected to an electromagnetic portion of an electromagnetic clutch transmitting or ceasing to transmit drive power of engine to the engine-driven compressor, or an electric motor control portion controlling rotation of an electric motor of the electric compressor, to control operation of the automotive air conditioner including the electromagnetic clutch or the electric motor, depending on the environmental parameters detected by the environmental parameter detection means, wherein
the air-con control unit consists of one type of a control unit producing and transmitting an electromagnetic-clutch engage/disengage signal based on environmental parameter signals transmitted from the environmental parameter detection means, and also retransmitting the environmental parameter signals, and
the electromagnetic portion of the electromagnetic clutch operates the engine-driven compressor by selectively receiving the electromagnetic-clutch engage/disengage signal transmitted from the air-con control unit and engaging or disengaging the electromagnetic clutch accordingly, and the electric motor control portion operates the electric compressor by selectively receiving the environmental parameter signals transmitted from the air-con control unit

2. The compressor controller according to claim 1, wherein
the electric motor control portion of the electric compressor selectively receives the environmental parameter signals, obtains a target revolving speed based on the environmental parameter signals, and control rotation of the electric motor according to the target revolving speed.

3. The compressor controller according to claim 1 or 2, wherein
the electromagnetic portion of the electromagnetic clutch of the engine-driven compressor is electrically connected to the air-con control unit, and the electric motor control portion of the electric compressor is connected to the air-con control unit by a LAN.

4. The compressor controller according to claim 1, wherein
the electromagnetic portion of the electromagnetic clutch of the engine-driven compressor is electrically connected to the air-con control unit, and the electric motor control portion of the electric compressor is connected to the air-con control unit by a LAN.
